(19) United States
(12) Patent Application Publication
(10) Pub. No.: US 2017/0212964 A1
(43) Pub. Date: Jul. 27, 2017

(54) System and method for dynamic content rendering

(71) Applicant: Veeva Systems Inc., Pleasanton, CA (US)

(72) Inventors: Jason D'anna, Toronto (CA); Li Feng, Plano, TX (US); Muhammet Harun Dericioglu, Toronto (CA); Cristian Curelaru, Etobicoke (CA)

(73) Assignee: Veeva Systems Inc., Pleasanton, CA (US)

(21) Appl. No.: 15/008,266

(22) Filed: Jan. 27, 2016

(51) Int. Cl. G06F 17/30

(52) U.S. Cl. CPC G06F 17/30896; G06F 17/30864

(57) ABSTRACT

Systems and methods for rendering dynamic content when converting a website to its static representation. A set of commands may be created with a syntax using the data attribute in HTML 5. Web designers may inject these attributes into the code of the webpages without affecting how the webpages will render in any browser that supports HTML 5. A specific and documented set of data attributes may indicate that the given element is a type of dynamic content. These data attributes will also indicate how to handle the dynamic elements such that a static representation of each visual state rendered in the browser may be generated accordingly.

### BACKGROUND

The subject technology relates generally to dynamic content rendering, and more specifically to dynamic content rendering when converting websites to portable document format (“PDF”) documents.

Sometimes users need to convert dynamic content (e.g., websites) to its static image (e.g., PDF documents) for the purpose of review (e.g. during an audit). The PDF document needs to contain a representation of webpages of the website with high fidelity so that the review process can easily correlate the content of the PDF document to that of the website. Each page of the PDF document corresponds to a webpage on the website and is saved as an image snapshot of the webpage. Since webpage content is highly dynamic, it is challenging to translate the website as it appears in a browser (interactive and dynamic) to a static image. Thus, it is desirable to provide a method for rendering dynamic content during the conversion.

### SUMMARY

The disclosed subject matter relates to a method for rendering dynamic content when converting a website to its static representations. The method comprises: receiving a request for static representations of a website over a network, wherein the website comprises a first webpage. The method further comprises: determining that code of the first webpage comprises a dynamic content rendering attribute, wherein the dynamic content rendering attribute defines a dynamic interaction with the first webpage including a type of the dynamic interaction and an area on the first webpage for receiving the interaction. The method further comprises: enabling the dynamic interaction with the first webpage based on the dynamic content rendering attribute, including enabling the type of the dynamic interaction on the area on the first webpage for receiving the interaction; generating a static representation of the first webpage updated with the dynamic interaction: and sending the static representation in response to the request.

### BRIEF DESCRIPTION OF THE DRAWINGS

FIG. 1 illustrates an example high level block diagram of a content converting architecture wherein the present invention may be implemented.

FIG. 2 illustrates an example block diagram of a computing device.

FIG. 3 illustrates an example high level block diagram of the content converting server according to one embodiment of the present invention.

FIGS. 4A-4H illustrate a flowchart of a method for converting websites to PDF documents according to one embodiment of the present invention.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, well-known structures and components are shown in block diagram form in order to avoid obscuring the concepts of the subject technology.

The subject technology is directed to techniques for converting websites to their static representations (e.g., PDF documents). Website content is highly dynamic and interactive, and some examples of dynamic website content include:

1. Carousel, a bounding area on a page through which images rotate, either timed or by clicking a control on the Carousel;

2. Accordion, a clickable image or area which expands and/or contracts a section of the page; and

3. Floating ISI (Important Safety Information), which ensures that safety information about a product appears in a floating element on the webpage, occupying at least some percentage of the browser, and expandable to the full length of the browser window.

To address this challenge, the desired result is to represent each potential visual state of a webpage with a distinct static representation, e.g., in a PDF document. The aggregate of static representations (e.g., snapshots contained in the PDF document) for a given webpage thus demonstrates all the visual representations that content can take, giving reviewers' access to each element as it can possibly be rendered in the browser. The relationship of a webpage to static snapshots in the PDF document is one to many. For example, a carousel that has six images cycling through display should have six static images in the PDF document, each depicting the webpage as it looks with the various images.

Detecting dynamic contents on a webpage and taking the required interactive action is difficult given the complexity of the problem. Implementations of these UI elements are many and various, so there are no standard identifiers to indicate that a given portion of web code, whether HTML or Javascript, will behave in a dynamic manner nor what actions it will take while executing. Consequently, it is difficult to create a generic handling mechanism so that the dynamic content can be captured.

To solve this problem, a set of commands may be created with a syntax using the data attribute in HTML 5. Web designers may inject these attributes into the code of the webpages without affecting how the webpages will render in any browser that supports HTML 5. A specific and documented set of data attributes may indicate that the given element is a type of dynamic content. These data attributes will also indicate how to handle the dynamic elements such that a static representation of each visual state rendered in the browser may be generated accordingly.

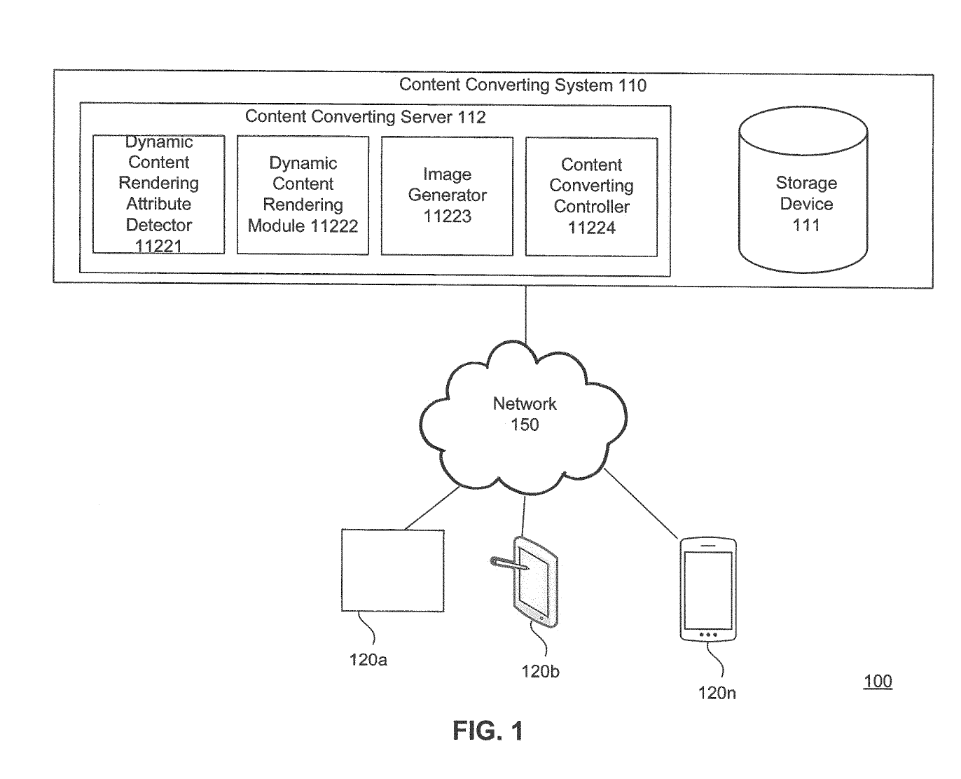

FIG. 1 illustrates an example high level block diagram of a content converting architecture 100 wherein the present invention may be implemented. As shown, the architecture 100 may include a content converting system 110, and a plurality of user computing devices 120a, 120b, . . . 120n, coupled to each other via a network 150. The network 150 may include one or more types of communication networks, e.g., a local area network (“LAN”), a wide area network (“WAN”), an intra-network, an inter-network (e.g., the Internet), a telecommunication network, and peer-to-peer networks (e.g., ad hoc peer-to-peer networks), which may be wired or wireless.

The user computing devices 120a-120n may be any machine or system that is used by a user to access the content converting system 110 via the network 150, and may be any commercially available computing devices including laptop computers, desktop computers, mobile phones, smart phones, tablet computers, netbooks, and personal digital assistants (PDAs).

The content converting system 110 may include a storage device 111 and a content converting server 112. The storage device 111 may temporarily store webpage static representation generated by the content converting server 112, and may be any commercially available storage devices.

The content converting server 112 is typically a remote computer system accessible over a remote or local network, such as the network 150. The content converting server 112 could be any commercially available computing devices. The content converting server 112 may have a dynamic content rendering attribute detector 11221 for detecting dynamic content rendering attributes in the code of a webpage, a dynamic content rendering module 11222 for receiving the dynamic content rendering attributes from the detector 11221 and enabling interactions with the webpage based on the dynamic content rendering attributes, an image generator 11223 for generating a static representation of the webpage after the interaction, and a content converting controller 11224 for authenticating users and sending them the static representation.

In one implementation, the content converting system 110 may be used with a multi-tenant content management system where various elements of hardware and software may be shared by one or more customers. For instance, a server may simultaneously process requests from a plurality of customers, and the content management system may store content for a plurality of customers. In a multi-tenant system, a user is typically associated with a particular customer. In one example, a user could be an employee of one of a number of pharmaceutical companies which are tenants, or customers, of the content management system.

In one embodiment, the content converting system 110 may run on a cloud computing platform. Users can process content on the cloud independently by using a virtual machine image, or purchasing access to a service maintained by a cloud database provider.

In one embodiment, the content converting system 110 may be provided as Software as a Service (“SaaS”) to allow users to access it with a thin client.

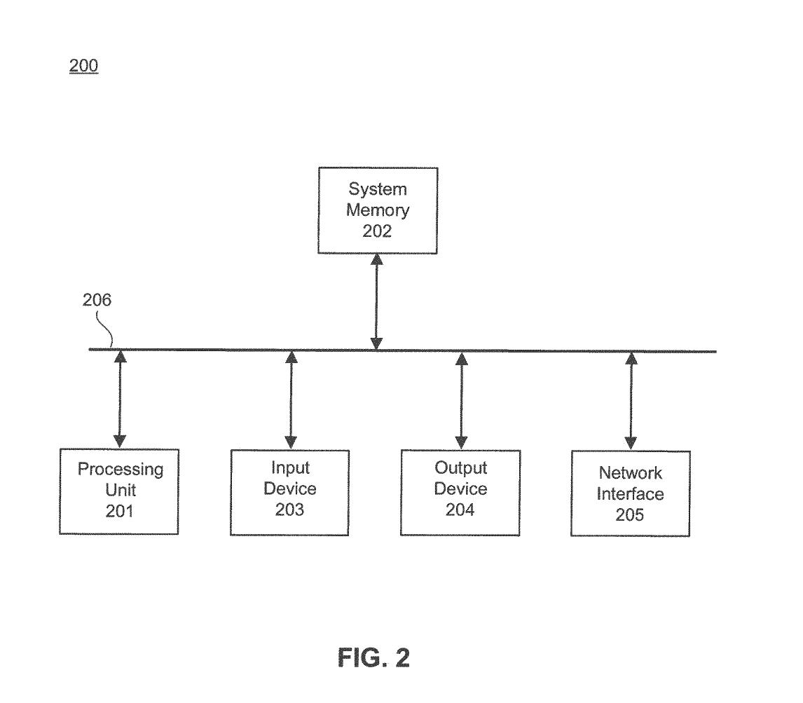

FIG. 2 illustrates an example block diagram of a computing device 200 which can be used as the user computing devices 120a-120n, and the content converting server 112 in FIG. 1. The computing device 200 is only one example of a suitable computing environment and is not intended to suggest any limitation as to scope of use or functionality. The computing device 200 may include a processing unit 201, a system memory 202, an input device 203, an output device 204, a network interface 205 and a system bus 206 that couples these components to each other.

The processing unit 201 may be configured to execute computer instructions that are stored in a computer-readable medium, for example, the system memory 202. The processing unit 201 may be a central processing unit (CPU).

The system memory 202 typically includes a variety of computer readable media which may be any available media accessible by the processing unit 201. For instance, the system memory 202 may include computer storage media in the form of volatile and/or nonvolatile memory such as read only memory (ROM) and/or random access memory (RAM). By way of example, but not limitation, the system memory 202 may store instructions and data, e.g., an operating system, program modules, various application programs, and program data.

A user can enter commands and information to the computing device 200 through the input device 203. The input device 203 may be, e.g., a keyboard, a touchscreen input device, a touch pad, a mouse, a microphone, and/or a pen.

The computing device 200 may provide its output via the output device 204 which may be, e.g., a monitor or other type of display device, a speaker, or a printer.

The computing device 200, through the network interface 205, may operate in a networked or distributed environment using logical connections to one or more other computing devices, which may be a personal computer, a server, a router, a network PC, a peer device, a smart phone, or any other media consumption or transmission device, and may include any or all of the elements described above. The logical connections may include a network (e.g., the network 150) and/or buses. The network interface 205 may be configured to allow the computing device 200 to transmit and receive data in a network, for example, the network 150. The network interface 305 may include one or more network interface cards (NICs).

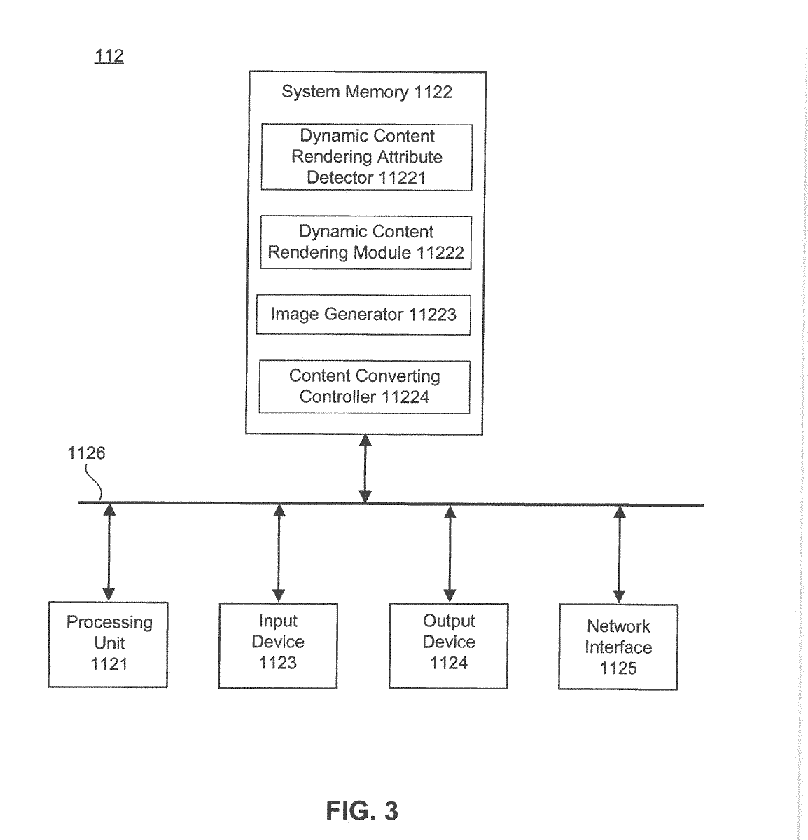

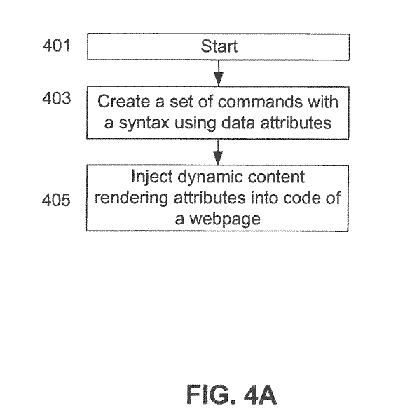

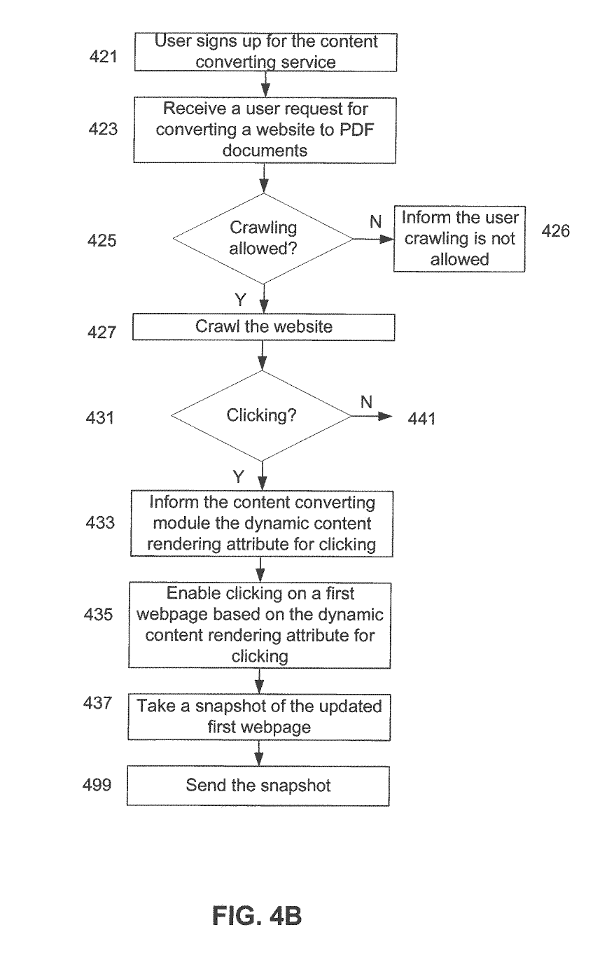

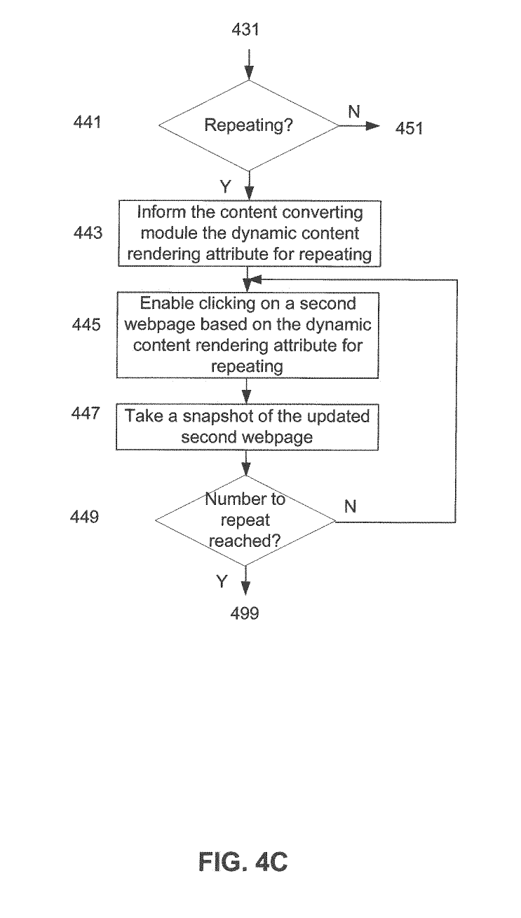

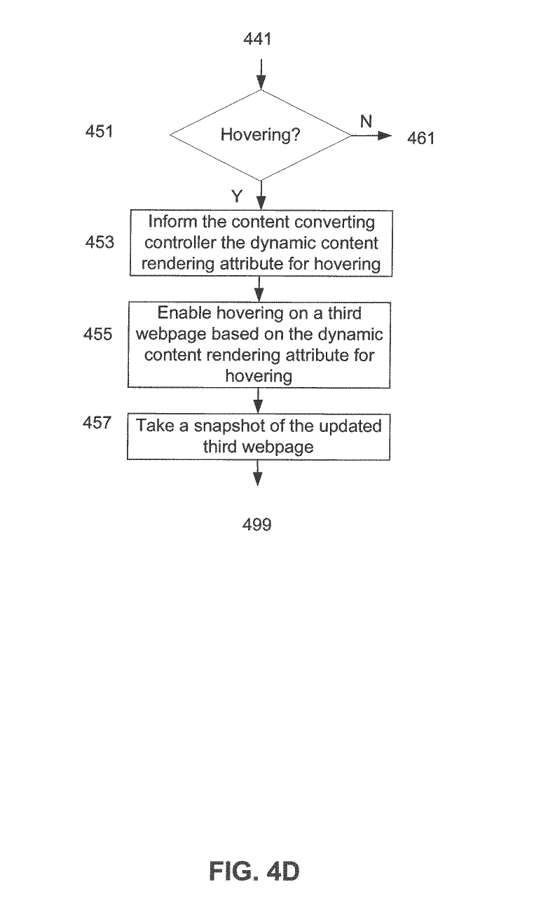

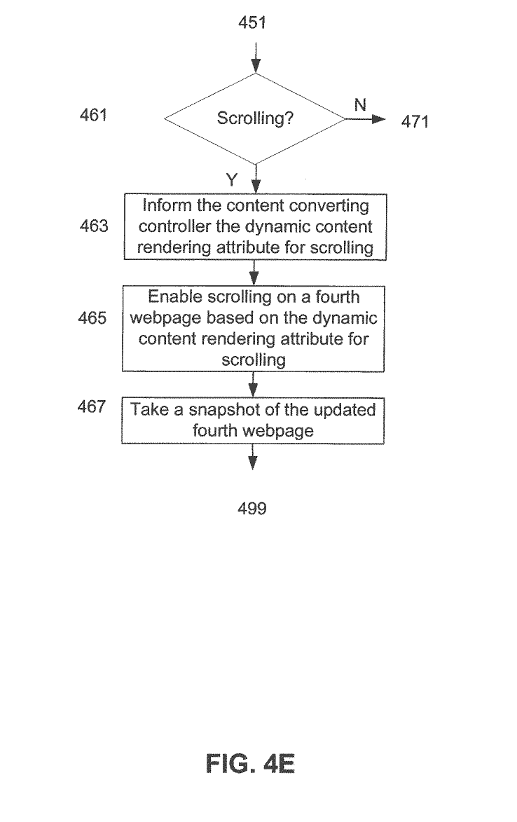

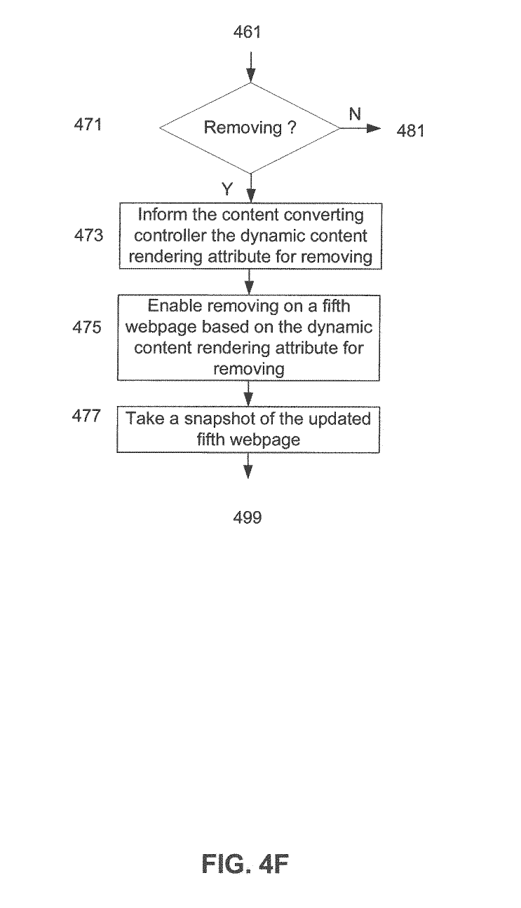

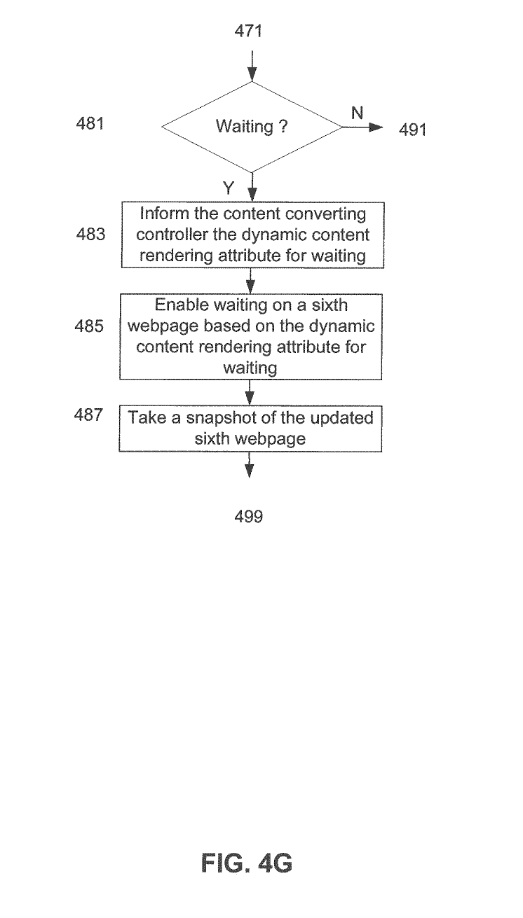

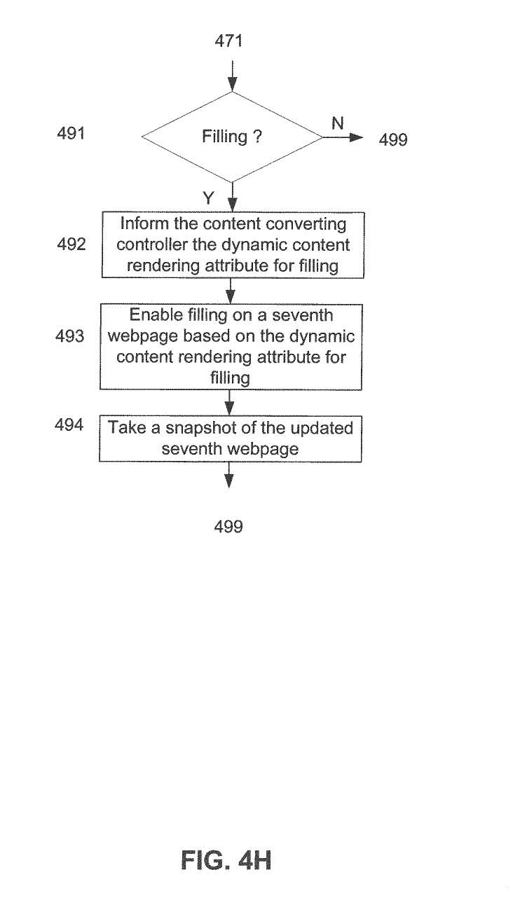

FIG. 3 illustrates an example high level block diagram of the content converting server 112 according to one embodiment of the present invention. The content converting server 112 may be implemented by the computing device 200, and may have a processing unit 1121, a system memory 1122, an input device 1123, an output device 1124, and a network interface 1125, coupled to each other via a system bus 1126. The system memory 1122 may store the dynamic content rendering attribute detector 11221, the dynamic content rendering module 11222, the image generator 11223, and the content converting controller 11224. FIGS. 4A-4H illustrate a flowchart of a method for converting websites to PDF documents in the content converting architecture 100 (as shown in FIG. 1) according to one embodiment of the present invention.

The process may start at 401.

At 403, a set of commands may be created with a syntax using the data attributes in HTML 5. An example of a data attribute may be: “data-vv-action”, with possible values “click”, “hover”, “remove”, “fill”, “fillSubmit”. It may instruct the dynamic content rendering module 11222 the type of action performed before next snapshot.

At 405, these dynamic content rendering attributes may be injected into the code of the webpages without affecting how the webpages will render in any browser that supports HTML 5. A specific and documented set of dynamic content rendering attributes may indicate that the given element is a type of dynamic content. These dynamic content rendering attributes will also indicate how to handle the dynamic elements such that a static representation of each visual state rendered in the browser may be created accordingly. An example of HTML code using these attributes to capture a carousel might be:

<div href=“#” class=“jcarousel-control-prev”>&lsaquo;</div>
<div data-vv-action=“click” data-vv-count=“3” data-vv-snapshot=“before”
href=“#”
class=“jcarousel-control-next”>&rsaquo;</div>

The data attributes above instruct the dynamic content rendering module 11222 to click on the carousel's navigation button three times and take a snapshot before every click.

At 421, a user may sign up for the service for converting websites to static representations (e.g., PDF documents). The user may provide his/her email address for receiving the PDF documents.

At 423, a user request may be received at the content converting system 110 for converting a website to PDF documents. The request may include the URL of the website.

At 425, it may be determined if the website allows crawling.

If not, the user may be informed at 426.

If yes, the website may be crawled at 427.

Then, it may be determined if there is any dynamic content rendering attributes, e.g., those include “data-vv-”, in the webpages of the website. For example, at 431, it may be determined (e.g., by the dynamic content rendering attribute detector 11221) if there is a dynamic content rendering attribute in the code of the first webpage for clicking on the first webpage, which may be used for carousels and accordions. If not, the process may proceed to 441. If yes, at 433, the dynamic content rendering module 11222 may be informed of the dynamic content rendering attribute for clicking, and at 435, the dynamic content rendering module 11222 may enable a click on a control or image on the first webpage based on the dynamic content rendering attribute for clicking. The first webpage may be updated in response to the click. At 437, a static representation, e.g., a snapshot of the updated first webpage, may be generated by the image generator 11223 and saved in the storage device 111. The process may then proceed to 499.

At 441, it may be determined (e.g., by the dynamic content rendering attribute detector 11221) if there is a dynamic content rendering attribute for repeating an action on a second webpage for a predetermined number of times. An example of dynamic content rendering attribute may be: “data-vv-count”, and its value could be any integer value. It may be used on the <html> tags, and may instruct the dynamic content rendering module 11222 number of times an action (e.g., click) should be performed. Its default value may be set to 1.

If there is a dynamic content rendering attribute for repeating an action on a second webpage for a predetermined number of times, at 443, the dynamic content rendering module 11222 may be informed of the dynamic content rendering attribute for repeating, including the action to be repeated and how many times to repeat. For example, if the carousel contains four images, the dynamic content rendering attribute for repeating may inform the dynamic content rendering module 11222 to click on a specific icon on the second webpage for a predetermined number of times (e.g., six). At 445, the dynamic content rendering module 11222 may enable a click on the specific icon on the second webpage. The second webpage may be updated in response to the click. The process may proceed to 447 to generate a static representation, e.g., a snapshot of the updated second webpage, and save the static representation in the storage device 111. At 449, it may be determined if the predetermined number of times in the dynamic content rendering attribute for repeating has reached. If not, the process may return to 445. If yes, the process may then proceed to 499.

At 451, it may be determined (e.g., by the dynamic content rendering attribute detector 11221) if there is a dynamic content rendering attribute for hovering on a third webpage. If yes, at 453, the dynamic content rendering module 11222 may be informed of the dynamic content rendering attribute for hovering, and at 455, the dynamic content rendering module 11222 may enable mouse to hover over a predetermined area on the third webpage based on the dynamic content rendering attribute for hovering. The third webpage may be updated in response to the mouse hovering. At 457, a static representation, e.g., an image or a snapshot of the updated third webpage may be generated by the image generator 11223 while on hover, and saved in the storage device 111. The process may then proceed to 499.

At 461, it may be determined (e.g., by the dynamic content rendering attribute detector 11221) if there is a dynamic content rendering attribute for scrolling on a fourth webpage. If yes, at 463, the dynamic content rendering module 11222 may be informed of the dynamic content rendering attribute for scrolling, and at 465, the dynamic content rendering module 11222 may enable scrolling on the fourth webpage based on the dynamic content rendering attribute for scrolling. At 467, a static representation, e.g., an image or a snapshot may be taken by the image generator 11223 per scroll and saved in the storage device 111. The process may then proceed to 499.

At 471, it may be determined if there is a dynamic content rendering attribute for removing a floating ISI section on a fifth webpage. An example of a data attribute may be: “data-vv-isi”, with a possible value “true”. It may be used on the <body> or <html> tags, and may be set to “true” on a page that has a floating ISI.

If yes, at 473, the dynamic content rendering module 11222 may be informed of the dynamic content rendering attribute for removing, and at 475, the dynamic content rendering module 11222 may enable removing the floating ISI section on the fifth webpage based on the dynamic content rendering attribute for removing. The fifth webpage may be updated in response. At 477, a static representation, e.g., an image or a snapshot of the webpage underneath may be taken by the image generator 11223, and saved in the storage device 111. The process may then proceed to 499.

At 481, it may be determined if there is a dynamic content rendering attribute for waiting for a predetermined period of time before generating a static representation of a sixth webpage. An example of the dynamic content rendering attribute may be: “data-vv-waitAfter”, and its value could be any integer value. It may be used on the <html> tags, and may instruct the dynamic content rendering module 11222 number of milliseconds to wait after the action to take a snapshot. Its default value may be 1000, for 1000 milliseconds.

If yes, at 483, the dynamic content rendering module 11222 may be informed of the dynamic content rendering attribute for waiting, and at 485, the dynamic content rendering module 11222 may enable waiting on the sixth webpage based on the dynamic content rendering attribute for waiting. At 487, it may be determined if the predetermined period of time has passed. If yes, at 489, a static representation, e.g., an image or a snapshot of the sixth webpage may be generated by the image generator 11223 and saved in the storage device 111. The process may then proceed to 499.

At 491, it may be determined if there is a dynamic content rendering attribute for filling a field on a seventh webpage with a specific value. An example of dynamic content rendering attribute may be: “data-vv-fillValue”, and its value could be <username>, <password>, or custom text. It may be used on the <html> tags, along with data-vv-action=“fill”. This can be for form-based authentication or just text filling in general. For authentication, “<username>” and “<password>” will be recognized as tokens to retrieve the credentials from the main page's form. Otherwise, general text in this attribute will be used to fill the field. The user may also need to put the following on a button or element so that the form or whatever is filled on the page gets submitted: data-vv-action=“fillSubmit”.

If there is a dynamic content rendering attribute for filling a field on a seventh webpage with a specific value, at 493, the dynamic content rendering module 11222 may be informed of the dynamic content rendering attribute for filling, and at 495, the dynamic content rendering module 11222 may enable filling a field on the seventh webpage with the specific value based on the dynamic content rendering attribute for filling. The filling may be done through label matching. The process may then proceed to 499.

If the filling function is used to handle form authentication, special tokens may be provided to allow users to specify that they would like to populate fields using login and password provided during the initial crawl request. The tokens may be: {site_login}, {site_password}. At 497, a static representation, e.g., an image or a snapshot of the seventh webpage with the fields filled may be taken by the image generator 11223 and saved in the storage device 111. The process may then proceed to 499.

A further example of a data attribute may be: “data-vv-pageWait”, and its value could be any integer value. It may be used on the <body> or <html> tags, and may instruct the dynamic content rendering module 11222 number of milliseconds to wait after the main page loads before taking snapshots. Its default value may be 0.

A further example of dynamic content rendering attribute may be: “data-vv-seq”, and its value could be any integer value. It may be used on the <html> tags, and may instruct the dynamic content rendering module 11222 of the sequence order in which actions should be performed when there is more than one action on the page.

A further example of dynamic content rendering attribute may be: “data-vv-snapshot”, and its value could be “before”, “after”, or “never”. It may be used on the <html> tags, and may instruct the dynamic content rendering module 11222 when to take a snapshot. Default value may be “after”.

A further example of dynamic content rendering attribute may be: “data-vv-isiframe”, and its value could be “true”, “expand”, or “collapse”. It may be used on the <html> tags, and may be used to collapse or expand any floating elements (e.g. floating ISI).

It should be understood that more or fewer attributes may be used. In addition, some of these attributes may be used in combination with other attributes, such as wait, repeat and fill.

At 499, the saved static representations may be sent to the user email address, e.g., as PDF documents.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives. EPROMs, etc. The computer readable media does not include carrier waves and electronic signals passing wirelessly or over wired connections.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

In this specification, the term “software” is meant to include firmware residing in read-only memory or applications stored in magnetic storage, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs. Examples of computer programs or computer code include machine code, for example is produced by a compiler, and files including higher-level code that are executed by a computer, an electronic component, or a microprocessor using an interpreter.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more.

What is claimed is:

1. A computer-implemented method for converting a website to static representations, the method comprising:
receiving a request for static representations of a website over a network, wherein the website comprises a first webpage;
determining that code of the first webpage comprises a dynamic content rendering attribute, wherein the dynamic content rendering attribute defines a dynamic interaction with the first webpage and comprises a type of the dynamic interaction and an area on the first webpage for receiving the interaction;
enabling the dynamic interaction with the first webpage based on the dynamic content rendering attribute, comprising enabling the type of the dynamic interaction on the area on the first webpage for receiving the interaction;
generating a static representation of the first webpage updated with the dynamic interaction; and
sending the static representation in response to the request.

2. The method of claim 1, further comprising: determining that the website allows crawling and then crawling the website.

3. The method of claim 1, wherein the static representation comprises a PDF document.

4. The method of claim 1, wherein the dynamic interaction is to click on a first area on the first webpage.

5. The method of claim 1, wherein the dynamic interaction is to repeat an action on a second webpage for a predetermined number of times, and the method further comprises determining if the predetermined number of times has been reached.

6. The method of claim 1, wherein the dynamic interaction is to hover over a third webpage.

7. The method of claim 1, wherein the dynamic interaction is to scroll a fourth webpage.

8. The method of claim 1, wherein the dynamic interaction is to remove a floating ISI section on a fifth webpage.

9. The method of claim 1, wherein the dynamic interaction is to wait for a predetermined period of time before generating an image of a sixth webpage.

10. The method of claim 1, wherein the dynamic interaction is to fill a field on a seventh webpage with a specific value.

11. A system for converting a website to static representations, comprising:
a storage device; and
a content converting server for:
receiving a request for static representations of a website over a network, wherein the website comprises a first webpage;
determining that code of the first webpage comprises a dynamic content rendering attribute, wherein the dynamic content rendering attribute defines a dynamic interaction with the first webpage and comprises a type of the dynamic interaction and an area on the first webpage for receiving the interaction;
enabling the dynamic interaction with the first webpage based on the dynamic content rendering attribute, comprising enabling the type of the dynamic interaction on the area on the first webpage for receiving the interaction;
generating a static representation of the first webpage updated with the dynamic interaction;
storing the static representation to the storage device; and
sending the static representation in response to the request.

12. The system of claim 11, wherein the static representation comprises a PDF document.

13. The system of claim 11, wherein the dynamic interaction is to click on a first area on the first webpage.

14. The system of claim 11, wherein the dynamic interaction is to repeat an action on a second webpage for a predetermined number of times, and the method further comprises determining if the predetermined number of times has been reached.

15. The system of claim 11, wherein the dynamic interaction is to hover over a third webpage.

16. The system of claim 11, wherein the dynamic interaction is to scroll a fourth webpage.

17. The system of claim 11, wherein the dynamic interaction is to remove a floating ISI section on a fifth webpage.

18. The system of claim 11, wherein the dynamic interaction is to wait for a predetermined period of time before generating an image of a sixth webpage.

19. The system of claim 11, wherein the dynamic interaction is to fill a field on a seventh webpage with a specific value.

20. A non-transitory computer-readable medium for rendering dynamic content when converting a website to its static representation, the computer-readable medium comprising instructions that, when executed by a computer, cause the computer to:
receive a request for static representations of a website over a network, wherein the website comprises a first webpage;
determine that code of the first webpage comprises a dynamic content rendering attribute, wherein the dynamic content rendering attribute defines a dynamic interaction with the first webpage and comprises a type of the dynamic interaction and an area on the first webpage for receiving the interaction;
enable the dynamic interaction with the first webpage based on the dynamic content rendering attribute, comprising enabling the type of the dynamic interaction on the area on the first webpage for receiving the interaction;
generate a static representation of the first webpage updated with the dynamic interaction; and
send the static representation in response to the request.
